(19) United States
(12) Patent Application Publication
(10) Pub. No.: US 2002/0171690 A1
(43) Pub. Date: Nov. 21, 2002

(54) Method and system for scaling a graphical user interface (GUI) widget based on selection pointer proximity

(75) Inventors: James E. Fox, Apex, NC (US); Robert C. Leah, Cary, NC (US); Scott J. Mcallister, Cary, NC (US)

Correspondence Address: Gerald R. Woods, IBM Corporation, Dept. T81/Bldg. 503, P.O. Box 12195, Research Triangle Park, NC, 27709, US

(73) Assignee: International Business Machines Corporation, Armonk, NY (US)

(21) Appl. No.: 09/855,361

(22) Filed: May 15, 2001

(51) Int. Cl. G06F 3/00

(52) U.S. Cl. 345/862

(57) ABSTRACT

On a display screen, the visual size of a graphical user interface (GUI) widget is scaled based on the distance between the GUI widget and a displayed selection pointer, such as an arrow pointer controlled by a mouse. As the selection pointer is moved toward or away from the widget, the widget changes size. This permits the widget to display additional information, such as icon text, as a user moves a selection pointer closer to the widget.

### BACKGROUND OF THE INVENTION

Graphical user interfaces (GUIs) running on personal computers and workstations are familiar to many. A GUI provides a user with a graphical and intuitive display of information. Typically, the user interacts with a GUI display using a graphical selection pointer, which a user controls utilizing a graphical pointing device, such as a mouse, track ball, joystick, or the like. Depending upon the actions allowed by the application of operating system software, the user can select a widget, i.e., a user-discernible feature of the graphic display, such as an icon, menu, or object, by positioning the graphical pointer over the widget and depressing a button associated with the graphical pointing device. Numerous software application programs and operating system enhancements have been provided to allow users to interact with selectable widgets on their display screens in their computer systems, utilizing graphical pointing devices.

Widgets are frequently delineated by visual boundaries, which are used to define the target for the selection pointer. Due to visual acuity of users and the resolution capabilities of most available displays, there is necessarily a lower boundary on the size of a selectable object that can be successfully displayed and made selectable via a GUI. Consequently, a limitation is impressed upon the type and number of widgets that may be depicted on a working GUI. The problem becomes much more apparent as the size of the display screen shrinks, a difficulty that is readily apparent in handheld portable and wireless devices. As the available display real estate on a device shrinks, object presentation becomes more compact and a selection pointer tracking requires, in itself, more manual dexterity and concentration on the user's part.

To overcome the difficulties discussed above, U.S. Pat. No. 5,808,601 entitled “Interactive Object Selection Pointer Method and Apparatus”, hereby incorporated by reference, proposes a GUI system that models invisible force fields associated with displayed widgets and selection pointers. The '601 system relies on an analog to a gravitation force field that is generated mathematically to operate between the displayed image of the selection pointer on the screen of a display as it interacts with widgets on the screen. Under this scheme, the conventional paradigm of interaction between the selection pointer and widgets is changed to include effects of “mass” as represented by an effective field of force operating between the selection pointer display and various widgets on the screen. When the displayed selection pointer position on the screen comes within the force boundary of a widget, instantaneous capture of the selection pointer to the object whose force boundary has been crossed can be achieved. This makes it easier for users to select widgets, particularly on small display screens.

Although the force field concept described in the '601 patent represents a significant improvement in graphical user interfaces, there is room for improvement. For instance, the ability to adaptively vary the visual size of particular widget(s) would enhance the flexibility of the system described by the '601 patent.

### SUMMARY OF THE INVENTION

In view of the foregoing, the present invention provides a method and system for scaling the visual size of displayed widgets based on the proximity of a displayed selection pointer. According to one embodiment of the invention, on a display screen, the visual size of a GUI widget is scaled based on the distance between the GUI widget and a displayed selection pointer, such as an arrow pointer controlled by a mouse. As the selection pointer is moved toward or away from the widget, the widget changes size. This permits the widget to display additional information, such as icon text or refined graphical detail, as a user moves a selection pointer closer to the widget.

### BRIEF DESCRIPTION OF THE DRAWINGS

The foregoing and other features and advantages of the invention will become further apparent from the following detailed description of the presently preferred embodiments, read in conjunction with the accompanying drawings. The detailed description and drawings are merely illustrative of the invention rather than limiting, the scope of the invention being defined by the appended claims and equivalents thereof.

FIG. 1 is a flow chart of a method for implementing force field boundaries around widgets that are selectable on a display screen using a selection pointer device such as a mouse.

FIG. 2 depicts the selection of a widget mass by an end user.

FIG. 3 illustrates, in three progressive steps as depicted in FIGS. 3A-C, the pictorial demonstration of the effects of the force field concept in operation on a displayed widget.

FIG. 4 illustrates in a pre-selection indicator corresponding to a widget.

FIG. 5 illustrates in greater detail the interaction of multiple widgets having intersecting or overlapping force fields on a display device.

FIG. 6, as depicted in FIGS. 6A-C, illustrates an example of a selection pointer arrow interacting with a selectable widget on a display screen.

FIG. 7 illustrates an example in which overlapping and non-overlapping force field boundaries surround a plurality of selectable widgets or functions invocable in a graphical user interface presented on a display screen.

FIG. 8 is a flow chart of a method of scaling a widget based on the effective force field between the widget and a selection pointer in accordance with an embodiment of the invention.

FIG. 9 illustrates a pictorial demonstration of widgets scaling in size based on the proximity of a selection pointer in accordance with a further embodiment of the invention.

FIG. 10 illustrates an exemplary computer system utilizing the widgets as described herein.

### DETAILED DESCRIPTION OF THE PRESENTLY PREFERRED EMBODIMENTS

As mentioned above, an analogy to the basic gravitational law of physics is applied to interactions between one or more fixed or moveable, selectable or unselectable widgets that may be depicted by a typical user application program on a GUI display screen or device. In such a system, a user, employing a pointing stick, joy stick, mouse or track ball device, for example, may make selections by positioning a displayed selection pointer on an appropriate widget and issuing a signal to the computer system that a selection is desired.

By artificially assigning a specific force field factor, analogous to the physical gravitational concept of mass, to each widget used in the construction of the GUI environment and to the selection pointer, interactions that should physically occur between real force fields and real objects, such as attraction or repulsion, can be simulated on the face of the display screen. For example, by assigning a specific mass to one widget that would be frequently selected on the GUI display, a selection pointer having an assigned mass value would be attracted to the object if it approached within a boundary surrounding the object, even if it has not crossed onto the object's visually depicted boundary itself. Attraction between the selection pointer could cause it to automatically position itself on the selectable “hot spot” required to interact with the depicted selectable object.

It should be understood that true gravity or force fields are not generated by the system and methods disclosed herein. Rather, via mathematical simulation and calculation, the effect of such force fields in the interaction between the objects can be easily calculated and used to cause a change in the displayed positioning of the objects or of the selection pointer. At the outset, however, several concepts are introduced before the specifics of the artificial analog to a gravity force field and its application are discussed.

To exploit the concept of a force field or gravity, the selection pointer's set of properties is split between two entities. The entities are referred to herein as the “real selection pointer” or “real pointer”, and the “virtual selection pointer” or “virtual pointer”. The real selection pointer and the virtual selection pointer divide the properties that are normally associated with conventional selection pointer mechanisms. In this dichotomy, the real pointer possesses the true physical location of the selection pointer as it is known to the computer system hardware. That is, the actual location of the pointer according to the system tracking mechanism of a computer is possessed by the real pointer.

The virtual selection pointer takes two other properties, namely the visual representation of the selection pointer's location to a user viewing the display and the representation of the pointer's screen location to application programs running on the computer system.

Thus, when a user makes a selection with the pointer mechanism, it is the virtual selection pointer's location whose positioning signals are used to signal the application program and allow it to deduce what widget a user is selecting, not the real selection pointer's actual physical location.

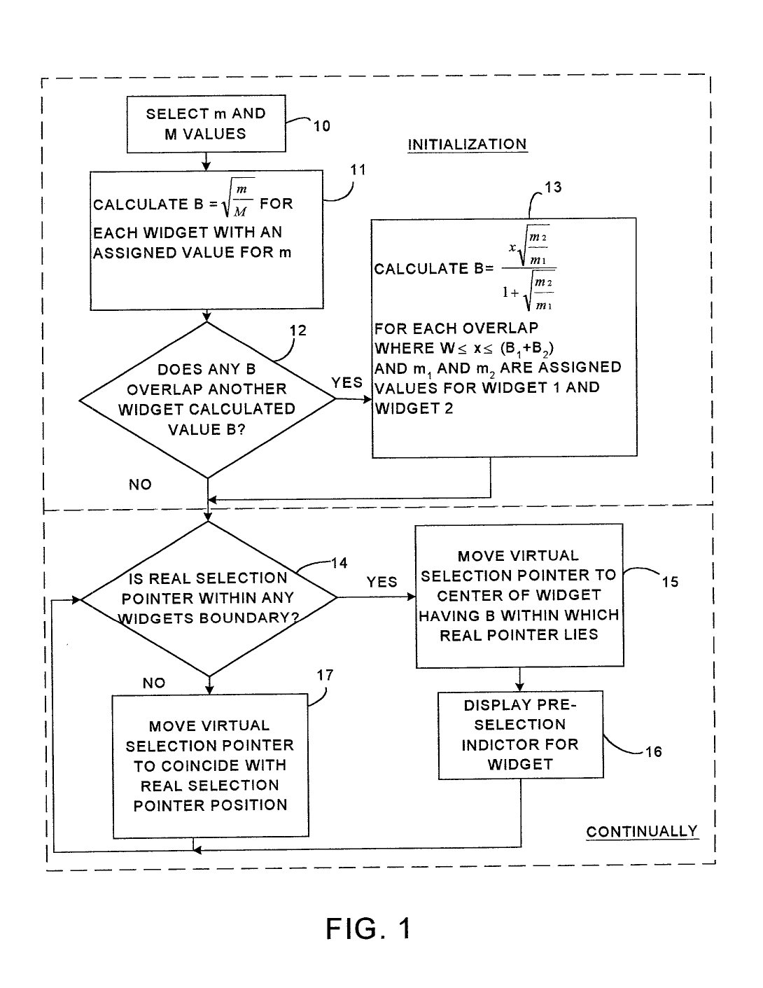

Turning to FIG. 1, the overall process and logic flow for implementing gravitation force boundaries for widgets will now be discussed. In box 10, the mass value m for each widget and the mass value M for the selection pointer are selected. The operating system provider, mouse driver provider or user can assign the mass value M to the selection pointer. To select the mass value m of a widget, the user can trigger an event, such as a predefined mouse click or pop-up menu, that presents a user interface for entering the widget mass value. By varying the mass value of the widget, a user can vary the effective force boundary surrounding the widget on a display screen, and thus, vary the degree of interaction between the widget and selection pointer.

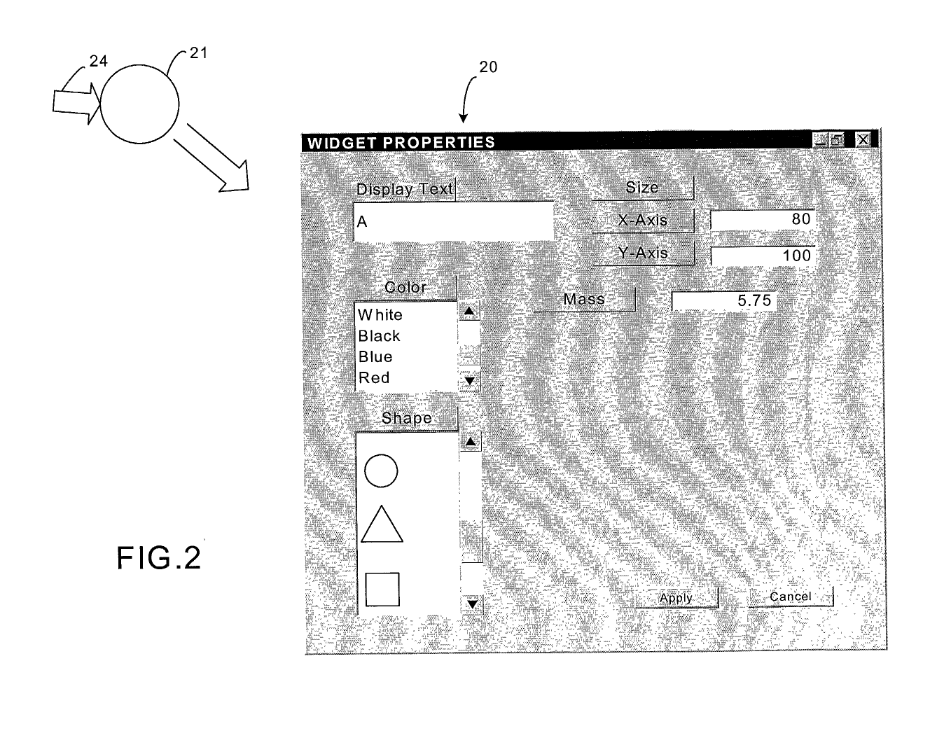

FIG. 2 shows an exemplary display screen depicting the selection of a widget mass by an end user. As shown, the user selects the widget 21 using the selection pointer 24. After selecting the widget, the user activates a triggering event, such as a predefined mouse button click or keystroke, to present a pop-up menu 20. The pop-up menu 20 provides a user interface for setting widget properties, such as the text displayed by the widget, widget size, color, shape, and the like. Of particular importance is an entry blank for setting the mass value m associated with the widget. This entry permits an end user to select the mass of the widget, and thus, vary the effective force boundary associated with the widget on a display screen.

After setting the widget properties, an end user can click on the ‘Apply’ button of the pop-up menu 20 to update the widget property values stored for the widget 21 by the computer system.

Returning to FIG. 1, in box 11, a value for the boundary dimension B is calculated for each widget on the screen to which a user or an application program designer has assigned a value for m. Since the well known formula for gravity, f=m/D², where m is the mass of an object, and D is the distance from the object's center of gravity at which the force is to be calculated, is well known, a method exists to calculate the boundary condition B at which the force is calculated to be equal to the mass M assigned to the selection pointer. At this condition being calculated, it may be deemed that the effective “mass” of the selection pointer M will be overcome by the force f between it and an object. It is only when the selection pointer displayed on the screen is overcome by the force of gravity that the virtual selection pointer, which is the actual displayed pointer on the screen, separates from the real, undisplayed, selection pointer physical position to be attracted to or repelled from the object's mass. The real selection pointer has no visual representation, but the virtual selection pointer is displayed at a location which is under the control of a user until the displayed location moves within a boundary B where the acting calculated force exceeds the assigned mass value given to the selection pointer in the program. It is then that the virtual selection pointer displayed moves, by virtue of the fact that the control program depicted in FIG. 1 causes it to do so.

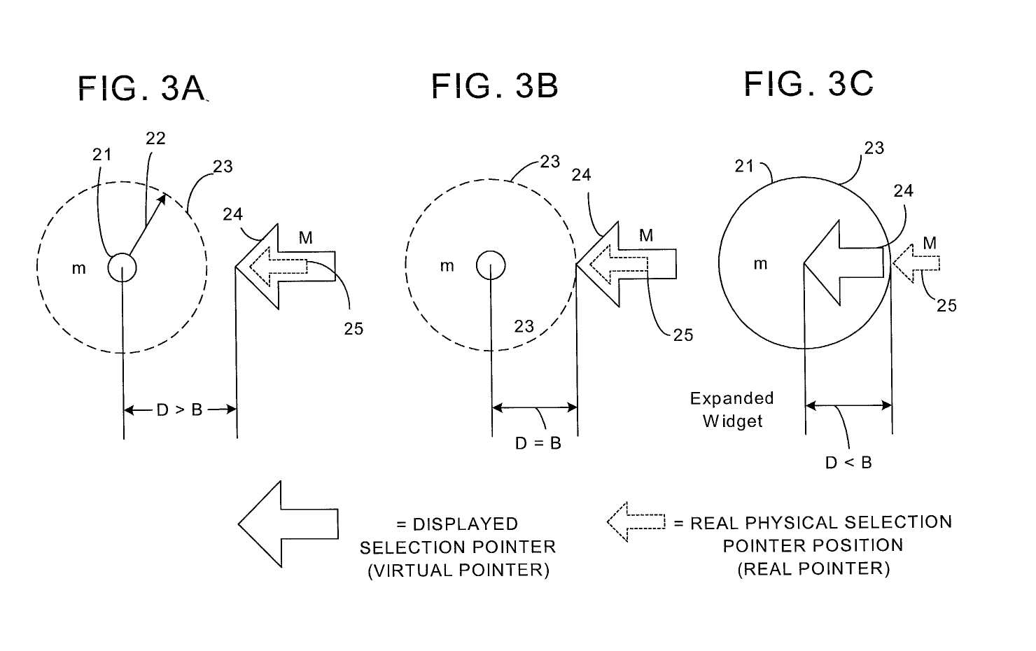

So long as the force calculated between the displayed selection pointer position and the widget having a mathematical mass value m does not overcome the assigned value of mass M of the selection pointer, the virtual and real selection pointers and have the same location, i.e., they coincide wherever the user positions the displayed selection pointer. However, when the force calculated from the aforementioned simple law of gravity exceeds the mathematical mass value M, the selection pointer personality. The boundary condition at which the calculated force would be greater or equal to the mass value M is calculated from the basic law of gravity so that B is equal to the square root of m divided by M. The calculated boundary B surrounds the selectable object as shown in FIG. 3A with a boundary 23 having a dimension B as depicted by designation numeral 22 as it surrounds a selectable widget 21.

It may be noted here that, where the display is outfitted to depict and recognize three dimensions, the force field is actually spherical for a point source and interactions with a moveable selection pointer in all three dimension would be possible. However, given the two dimensional nature of most display screens and devices, the interaction of the pointer and the widget is described herein specifically for two dimensions.

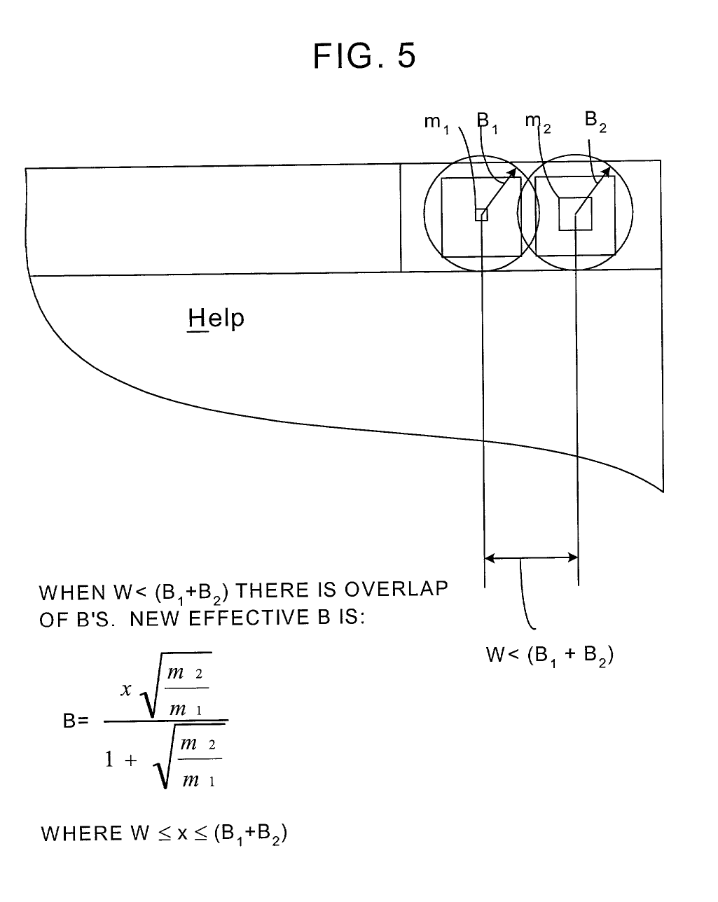

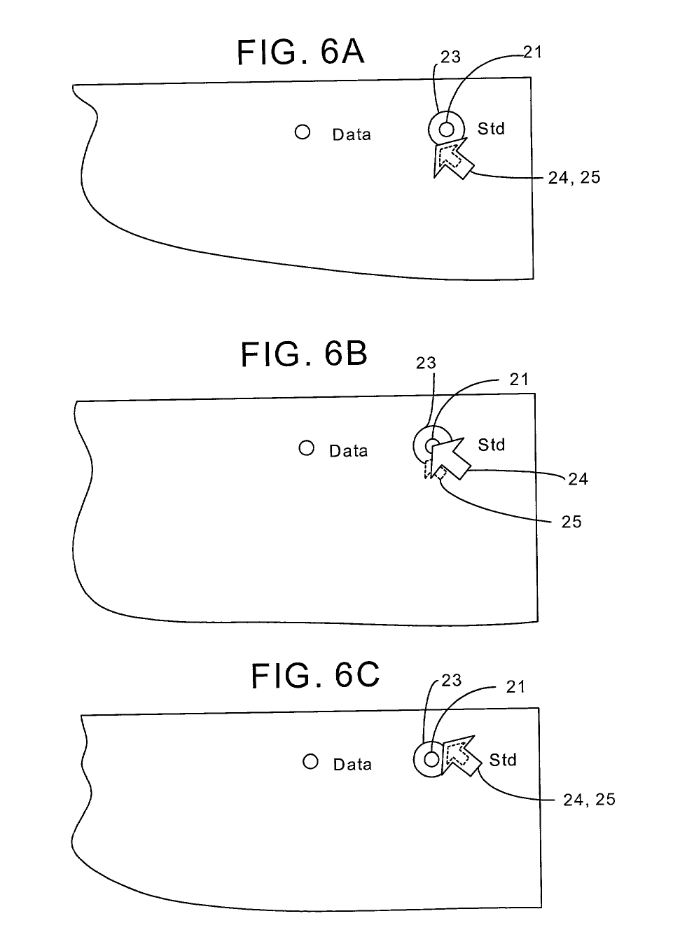

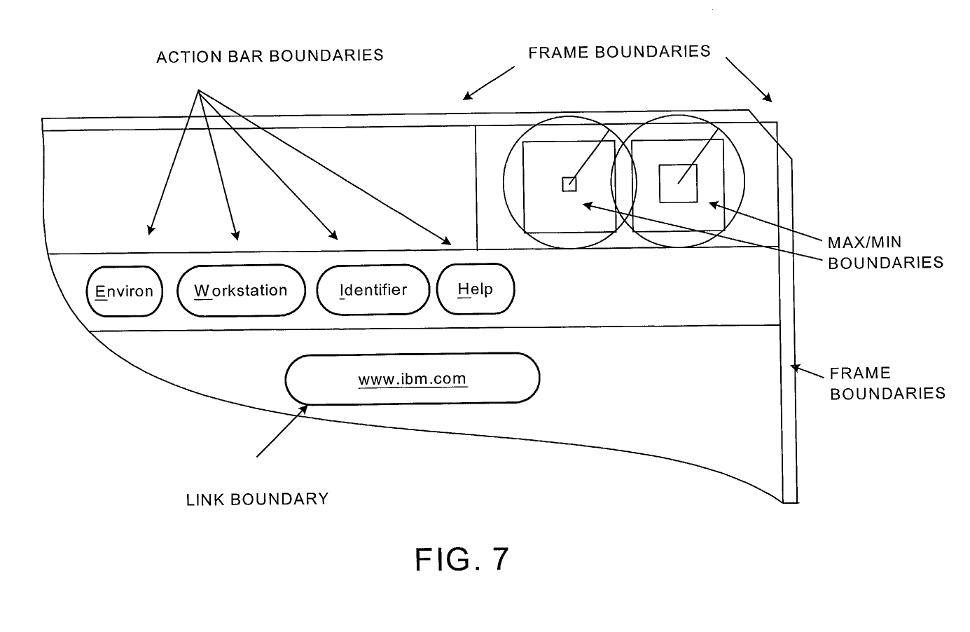

Graphically represented, the boundary B for a widget point mass m is a circle about a center of gravity having a radius B. If the center of mass of an object was in a line, whether straight or curved, then the boundary would be a dimension of constant distance on a perpendicular to the line, and would be a cylinder in three dimensional space. In a two dimensional screen system, however, the cylinder instead intersects the plane of the screen display in two lines, both of which are parallel to the center of gravity line of the object. A boundary of this type around elongated menu item selection areas is depicted in FIG. 7, for example, and is depicted around a selectable button in FIGS. 6A-C, and around rectangular or square buttons assigned point source mass functions in FIG. 5, for example.

Returning to the discussion of FIG. 1, the boundary dimension B is calculated as stated for each object on a user's display screen, which has been assigned a mass value m. Next, the question is asked in box 12 by the selection pointer control program, whether any widget's boundary B overlaps another widget's calculated boundary value B. If the answer is yes, a more complex calculation for the effective radius or dimension of the boundary (box 13) is necessary and is described in greater detail in connection with FIG. 5.

With regard to box 13 that a more complex calculation for the boundary B would be necessary if multiple objects have calculated boundaries that overlap. This condition is illustrated in FIG. 5 in which two selectable objects m₁ and m₂ having boundaries B₁ and B₂ are depicted. The distance between the centers of action of the two objects is shown as W, which is less than the sum of the boundary dimensions B₁+B₂. When this condition is true, the boundary value B that results is calculated as shown in Box 13 of FIG. 1 over a range of values for a variable x which lies in the range between W and the sum of B₁+B₂. It is this value of the effective boundary B that is utilized in the process to determine whether the actual physical position of the selection pointer lies within the boundary B when there is an overlap of boundaries condition as detected in box 12 of the process in FIG. 1. If there is an overlap, it is this value of B which is used as the test in box 14.

Returning to FIG. 1, following either calculation from box 11 or 13, box 14 is entered and the question is asked whether the real physical selection pointer position under control of the user lies within any object's boundary B. If the answer is yes, the control program logic of FIG. 1 causes the displayed virtual selection pointer 24 to move to the center of the widget 21 having the boundary B within which the real physical pointer 25 was determined to lie (box 15).

Concurrent with snapping the virtual selection pointer 24 to the center of the widget 21, a pre-selection indicator can be displayed prior to the user actually selecting the widget with, for example, a mouse button click (box 16). The pre-selection indicator provides visual feedback to a user as to which widget is about to be selected if the user takes further action with the selection pointer device. The pre-selection indicator can take the form of any suitable visual cue displayed by the screen in association with the widget, prior to user selection.

A first example of a pre-selection indicator may be envisioned with regard to FIG. 3 in which three consecutive FIGS. 3A-C, show interaction between the real physical selection pointer, the displayed selection pointer, and a selectable widget having a pre-selection indicator on a display screen in a computer system. In this example, the pre-selection indicator is provided by the widget 21 itself expanding in visual size.

In FIG. 3A, an arbitrary widget 21 on the face of the screen may depict a push button, for example. The push button 21 is assigned a mathematical mass value m. The displayed virtual selection pointer 24 and the real, physical selection pointer 25 have positions that coincide with one another, as shown in FIG. 3A, in most normal operation. That is, the user positions the selection pointers 24, 25 by means of his track ball, mouse tracking device, pointer stick, joy stick or the like in a normal fashion and sees no difference in operation depicted on the face of a display screen. However, the selection pointer 24 is deemed to be the “virtual pointer”, while the “real pointer” pointer 25 is assigned a mass value M.

In FIG. 3B, it is shown that the user has positioned the selection pointer to touch, but not cross, a boundary 23 calculated by the computer system process of FIG. 1 to exist at a radius or boundary dimension B surrounding the widget 21. It will be observed that in FIG. 3A, the dimension D between the selection pointer displayed and the active mass center of the widget 21 depicted on the screen is such that the boundary dimension 23 is much less that the distance D between the pointer and the widget. In FIG. 3B, the selection pointer is positioned just on the boundary where the dimension D equals the boundary dimension B. At this point, both the real physical pointer position and the displayed virtual pointer position still coincide, as shown in FIG. 3B.

However, turning to FIG. 3C, when the user positions the selection pointer to just cross the boundary dimension B, i.e., when the dimension D is less than or equal to B, the two entities of selection pointer become apparent.

As soon as the computer calculations indicate that the dimension D between the current selection pointer position of the real physical pointer 25, having the assigned mass M, and the widget 21, having assigned mass m, is less than the calculated dimension B for the radius of effect of the force field or gravity about the widget 21, the visually displayed position of the virtual selection pointer 24 snaps to the hot or selectable portion of the widget 21. In addition, the widget has expanded its visual size to the boundary B to present the pre-selection indicator.

The real physical location of the actual pointer 25 as operated by the controls under the user's hands has not changed in so far as the user is concerned; however, the visually observable effect is that the virtual selection pointer 24 has become attracted to and is now positioned directly on the widget 21, and the widget 21 has enlarged in size to the boundary 23. This effectively gives the user a range of selection and accuracy, which is the same dimension as the boundary B dimension for the perimeter of the force field 23 as shown. The user no longer need be as accurate in positioning the selection pointer.

Due to the fact that the force fields depicted are not real and no real gravity is involved, negative effects as well as positive effects may easily be implemented simply by changing the sign of the value of force field to be calculated, or assigning a negative value to one of the masses used in the calculation.

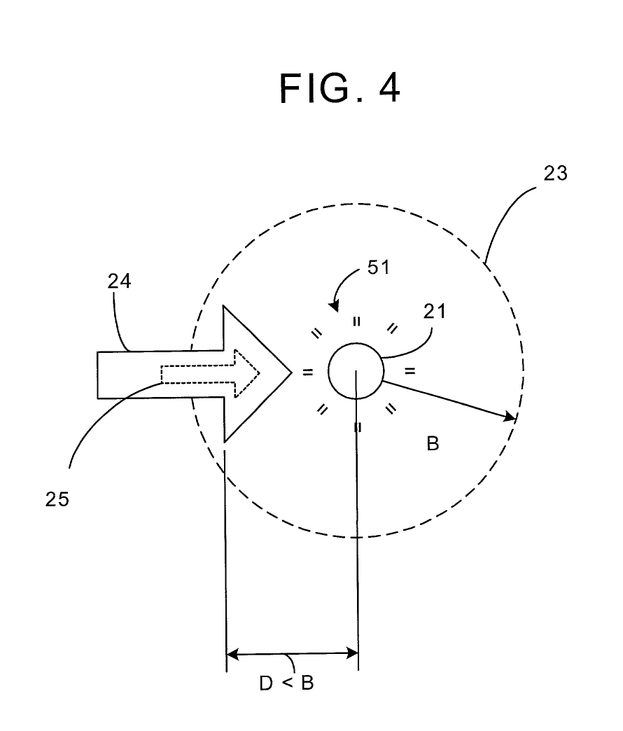

FIG. 4 illustrates a second example of a widget pre-selection indicator. In this example, a pre-selection aura 51 is displayed corresponding to the widget 21. The pre-selection aura 51 is an alternative to the widget enlargement shown in FIG. 3 for pre-selection indication. In the example shown, the aura 51 consists of a plurality of line pairs circumscribing the widget 21. The aura 51 is displayed on the screen when the actual selection pointer 25 moves within widget boundary, i.e., D<B. The aura 51 provides feedback to the user in response to movement of the selection pointer. Specifically, the aura 51 indicates that the user can select the widget 21, even though the selection pointer 25 has not actually reached the widget 21.

An alternative or addition to the aura 51 and the size enlargement of FIG. 3 is that the widget 21 can flash on the screen as a form of pre-selection indication.

Returning to FIG. 1, if the real physical pointer location 25 does not lie within any widget's boundary B, then the virtual pointer 24 displayed coincides with the real pointer position as shown in box 17. The process is iterative from boxes 14 through 17 as the user repositions the selection pointer around the screen of the user's display in his computer system.

Whenever the condition of box 14 is not met, i.e., when the real physical pointer position 25 lies outside of widget's boundary condition B, then the virtual pointer 24, which is actually the displayed selection pointer on the screen, is displayed to coincide with the real physical pointer position 25 under control of the user.

To illustrate this, a portion of a hypothetical display screen from a user's program showing a typical selection button widget for a data condition (being either “data” or “standard”) with the data and standard control buttons being potentially selectable as shown in FIG. 6A. The selectable object is button 21 which indicates a “standard” condition. Button 21 has an imaginary boundary B, shown as numeral 23, around it which would not be visible, but which is shown in this figure to illustrate the concept. The positionable selection pointer 24, 25 is both for the real and virtual pointer as shown in FIG. 6A where the user has positioned it to just approach, but not cross, the boundary 23 surrounding the selectable standard control button 21. In FIG. 6B, however, the user has repositioned the selection pointer controls so that the real physical position 25 has just intersected the boundary 23, at which time the distance d from the selection pointer 25 to the selectable widget 21 will be less than the dimension of the boundary B shown by the circle 23 in FIG. 6B. It is then that the virtual displayed selection pointer position 24 moves instantly to the center of the selectable button 21. If the user continues to move the actual physical selection pointer position 25 to eventually cross the boundary B going away from the selectable widget 21, the real and virtual selection pointers 24, 25 will again coincide as shown in FIG. 6C.

As shown in FIG. 6B, the virtual selection pointer 24, which is the actual displayed pointer, would appear to be “stuck” at the center of gravity of the selectable button 21, and would seemingly stay there forever. However, the calculated force acts upon the location that is calculated for the real, physical selection pointer 25, not on the depicted position of the actually displayed virtual selection pointer 24. Therefore, once the process of FIG. 1 calculates that the real physical pointer position no longer lies inside the dimension of boundary B surrounding a widget, the virtual selection pointer 24 which is displayed is moved by the program to coincide with the actual physical location which it receives from the user's mouse-driving selection mechanism.

FIG. 7 illustrates an implementation of the invention in which a plurality of selectable action bar items in a user's GUI, together with maximize and minimize buttons and frame boundaries about a displayed window of information, may all be implemented as widgets with gravitational effects. It should be noted that the boundaries shown about the various selectable items where the force boundary B is calculated to exist need not be shown and, in the normal circumstance, ordinarily would not be shown on the face of the display screen in order to avoid clutter. However, it would be possible to display the boundaries themselves, if it were so desired.

In addition to the above-described features of the GUI gravitational force system, the widgets displayed by such a system can be scalable based on the proximity of the displayed real selection pointer to the widgets. On a display screen, the visual size of a widget can be scaled based on the distance between the GUI widget and a displayed selection pointer. As the selection pointer is moved toward or away from the widget, the widget changes size. This permits the widget to display additional information, such as icon text, as a user moves a selection pointer closer to the widget.

With the artificial GUI gravitation force fields described herein, the scalability of a widget can be based on the gravitation force calculated to exist between a widget of mass m and the selection pointer of mass M. As given by the law of gravity, this gravity force value is inversely proportional to distance between the widget and the real selection pointer.

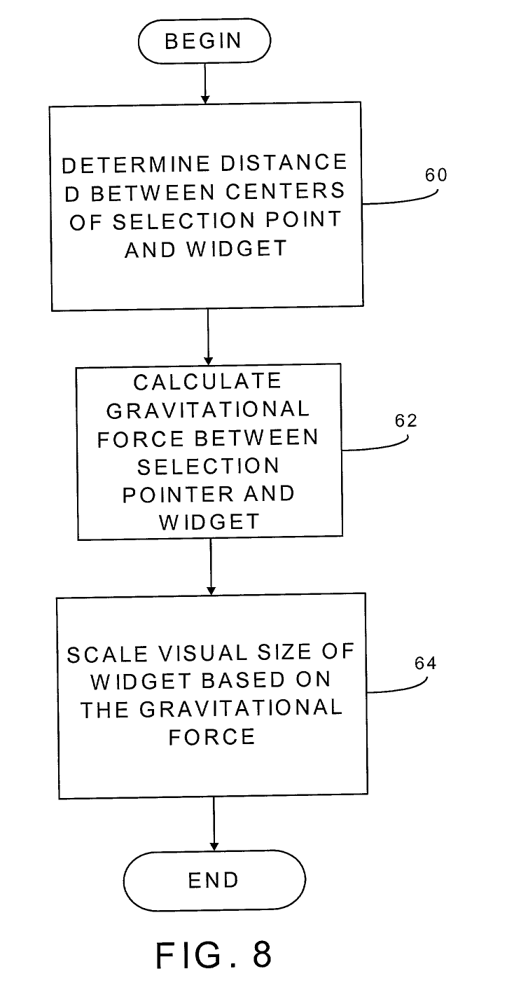

FIG. 8 is a flow chart of an exemplary method of scaling a widget based on the effective gravitational force field between the widget and a selection pointer, in accordance with an embodiment of the invention. In box 60, the distance D between the centers of the selection pointer and the widget is determined.

In box 62, the gravitational force between the selection pointer and widget is calculated. The well known formula for gravity, f=Mm/D , where m is the mass of the widget, M is the mass of the selection pointer, and D is the distance from the widget's center of gravity and the selection pointer, can be used for this calculation. This calculation can be repeated for each displayed widget having an assigned mass value, and can also be repeated as the selection pointer is moved on the screen to update the force value in real-time.

A threshold value can be set for the calculated force. If the calculated gravitational force falls below this threshold, then the widget is not affected by the selection pointer, and thus, does not scale in size because the force is too weak.

In box 64, the visual size of the widget is scaled as a factor of the calculated gravitational force. Thus, as the gravitational force between the widget and the selection pointer increases, i.e., the distance between the two decreases, the widget increases in size. The visual size can alternatively be scaled based on the boundary value B of the effected widget.

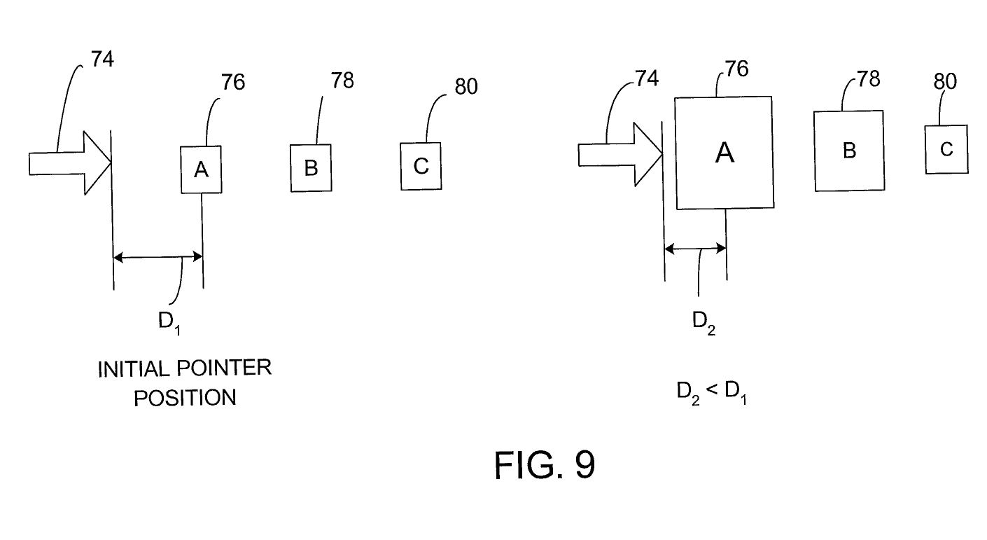

FIG. 9 illustrates a pictorial demonstration of widgets scaling in size based on the proximity of a selection pointer in accordance with the invention. The leftmost side of FIG. 9 shows a selection pointer 74 in an initial position at a distance D₁ from a first widget 76. In the initial position, the selection pointer 74 has no gravitational effect on the widgets 76-80, and therefore, the widgets 76-80 retain their original size.

The rightmost portion of FIG. 9 shows the selection pointer 74 moved closer to the widgets 76-80, to a second position distance D₂ from the first widget 76, where D₂<D₁. In the second position, the selection pointer 74 has a gravitational effect on widgets 76-78, causing them to enlarge in size due to the proximity of the pointer 74.

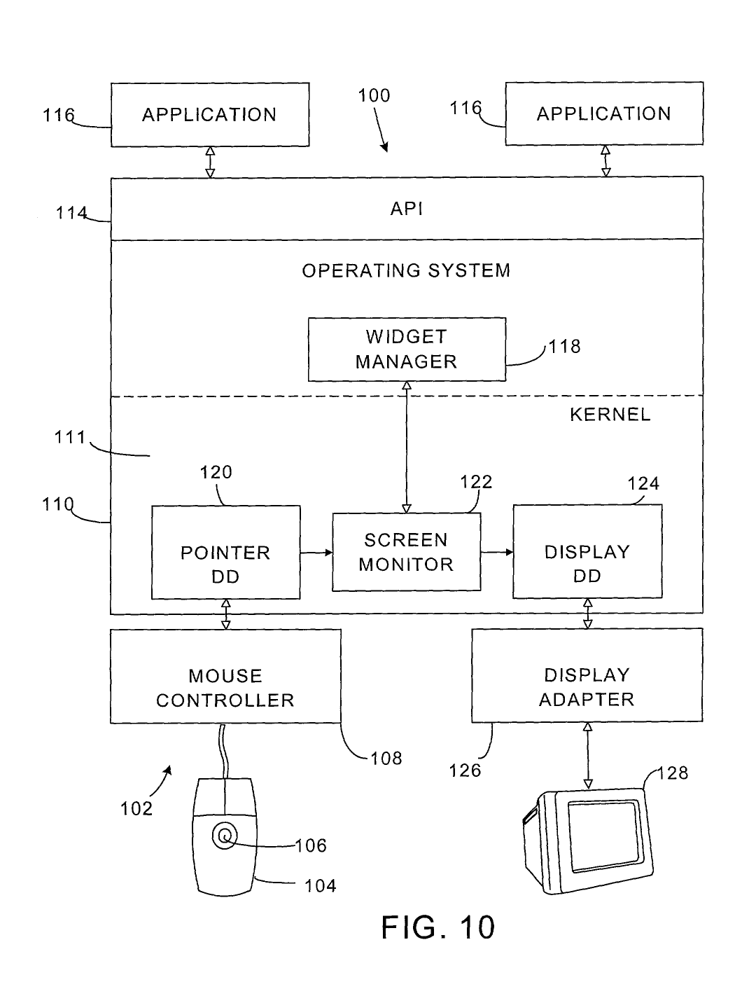

With reference now to FIG. 10, there is illustrated a pictorial representation of a computer system 100 capable of operating in accordance with the methods described herein. The system 100 comprises an operating system (OS) 110, which includes kernel 111, and one or more applications 116, which communicate with OS 110 through one or more application programming interfaces (APIs) 114. The kernel 111 comprises the lowest level functions of the OS 110 that control the operation of the hardware components of the computer system 100 through device drivers, such as graphical pointer device driver 120 and display device driver 124.

As illustrated, graphical pointer device driver 120 and display device driver 124 communicate with mouse controller 108 and display adapter 126, respectively, to support the interconnection of a mouse 104 and a display device 128.

In response to movement of a trackball 106 of the mouse 104, the mouse 104 transmits a graphical pointer signal to mouse controller 108 that describes the direction and rotation of the trackball 106.

The mouse controller 108 digitizes the graphical pointer signal and transmits the digitized graphical pointer signal to graphical pointer device driver 120, which thereafter interprets the digitized graphical pointer signal and routes the interpreted graphical pointer signal to a screen monitor 120, which performs GUI actions based on the position of the graphical selection pointer within display device 128. For example, screen monitor 120 causes a window to surface within a GUI in response to a user selection of a location within the window. Finally, the graphical pointer signal is passed to display device driver 124, which routes the data within the graphical pointer signal and other display data to the display adapter 126, which translates the display data into the R, G, and B signals utilized to drive display device 128. Thus, the movement of trackball 106 of mouse 104 results in a corresponding movement of the graphical selection pointer displayed by the display device 128.

In communication with the screen monitor 122 is a widget manager 118. The widget manager 118 can include software for performing the methods and processes described herein for managing widgets and selection pointers having effective force boundaries.

While the embodiments of the present invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

1. A method of displaying a graphical user interface (GUI) widget, comprising:
determining the distance D between a displayed GUI widget and a displayed selection pointer; and
scaling the visual size of the displayed GUI widget based on the distance D.

2. The method of claim 1, further comprising:
defining a mass value m associated with the displayed GUI widget;
defining a mass value M associated with the displayed selection pointer; and
scaling the visual size of the displayed GUI widget based on the mass values m and M and the distance D.

3. The method of claim 2, further comprising:
calculating B=\sqrt{m/M}; and
scaling the visual size of the displayed GUI widget as a function of B.

4. The method of claim 2, further comprising:
calculating a force value F=m*M/D²; and
scaling the visual size of the displayed GUI widget as a function of the force value F.

5. A computer-usable medium storing a computer program product for displaying a graphical user interface (GUI) widget, comprising:
means for determining the distance D between a displayed GUI widget and a displayed selection pointer; and
means for scaling the visual size of the displayed GUI widget based on the distance D.

6. The computer-usable medium of claim 5, further comprising:
means for defining a mass value m associated with the displayed GUI widget;
means for defining a mass value M associated with the displayed selection pointer; and
means for scaling the visual size of the displayed GUI widget based on the mass values m and M and the distance D.

7. The computer-usable medium of claim 5, further comprising:
means for calculating B=\sqrt{m/M}; and
means for scaling the visual size of the displayed GUI widget as a function of B.

8. The computer-usable medium of claim 5, further comprising:
means for calculating a force value F=m*M/D²; and
means for scaling the visual size of the displayed GUI widget as a function of the force value F.

9. A computer system, comprising:
a display;
a graphical user interface (GUI) presented by the display;
a widget displayed in the GUI, the widget having a mass value m associated therewith;
a selection pointer displayed in the GUI, the selection pointer having a mass value M associated therewith;
means for determining a distance D between the displayed widget and selection pointer; and
means for scaling the visual size of the displayed widget based on the mass values m and M and the distance D.

10. The computer system of claim 9, further comprising:
means for calculating B=\sqrt{m/M};and
means for scaling the visual size of the displayed widget as a function of B.

11. The computer system of claim 9, further comprising:
means for calculating a force value F=m*M/D²; and
means for scaling the visual size of the displayed widget as a function of the force value F.
